(19) United States
(12) Patent Application Publication
(10) Pub. No.: US 2024/0143487 A1
(43) Pub. Date: May 2, 2024

(54) SECURE TESTING OF ATTACHMENT FUNCTIONALITY OF OBJECTS

(71) Applicant: SAP SE, Walldorf (DE)

(72) Inventors: Ravikanth Malipeddu, Bangalore (IN); Aparna Vohra, Bangalore (IN); Ankit Dua, Gurugram (IN); Parmeshwar Lal, Gurugram (IN)

(73) Assignee: SAP SE, Walldorf (DE)

(21) Appl. No.: 17/975,482

(22) Filed: Oct. 27, 2022

(51) Int. Cl. G06F 11/36

(52) U.S. Cl. CPC G06F 11/3688; G06F 11/3692

(57) ABSTRACT

In a software testing environment, a computer implemented method receives a plurality of objects specified in different steps of a testing process. The method can identify, from the plurality of objects, a source object and at least one target object that share an attachment document which stored in a cloud-based data repository. The method can determine a unique reference of the attachment document from the source object, pass the unique reference to the at least one target object, and perform software testing on the at least one target object. The software testing on the at least one target object can verify that the attachment document stored in the cloud-based data repository is attached to the at least one target object via the unique reference.

### BACKGROUND

In performing transactions with other organizations, an organization can generate many electronic documents in the form of invoices, billing documents, goods receipts, etc. These documents can be sensitive in nature, for example, if they contain private and/or other non-disclosable information. As such, these sensitive documents can be stored in a secure and cloud-based data repository, and only authorized users of the organization are allowed to access these documents. The organization typically uses an enterprise software to manage different phases or steps of its transactions. Attachment functionality is a common feature in enterprise software. For example, in some circumstances, multiple steps of the transactions can refer to a shared document, which can be an attachment file linked to different data objects (or simply “objects” hereinafter), wherein each object models or represents a corresponding entity involved in the transactions. If a service provider of the enterprise software can access and create a local copy of the attachment file during testing and/or performing maintenance of the enterprise software, then it could potentially violate security compliance principles because there is a risk that sensitive information contained in the attachment file may be exposed to unauthorized users who get access to the local copy of the attachment file. Thus, room for improvements exists to provide a system and method that support secure testing of attachment functionality of objects in software application.

### BRIEF DESCRIPTION OF THE DRAWINGS

FIG. 1 is a diagram illustrating an example testing process involving multiple objects that share an attachment document.

FIG. 2 is an overall block diagram of an example system supporting secure software testing on objects sharing an attachment document.

FIG. 3 is a flowchart illustrating an example overall method of performing secure software testing on objects sharing an attachment document.

FIG. 4 depicts an example standard testing process and an example custom testing process derived from the standard testing process.

FIG. 5 depicts an example user interface for a user to identify a source or target object and example metadata that can uniquely identify an attachment file.

FIG. 6 is a block diagram of an example computing system in which described embodiments can be implemented.

FIG. 7 is a block diagram of an example cloud computing environment that can be used in conjunction with the technologies described herein.

### DETAILED DESCRIPTION

### Example 1—Overview of Testing Attachments Functionality of Objects and Related Data Security Considerations

Many organizations today use enterprise software to manage different phases or steps of transactions with other entities. Using an enterprise software, an organization can generate many electronic documents in the form of invoices, billing documents, goods receipts, etc., which may contain private and/or other non-disclosable information.

Many organizations today also use cloud-based solutions. One important concern for such organizations is the security aspects of their data. An organization can store documents that contain sensitive information in the organization's own content repository in the cloud, and only authorized users of the organization are allowed to access these documents.

The enterprise software is usually provided by a service provider, who may need to run the enterprise software for testing and/or other maintenance purposes. If the service provider of the enterprise software gains access to the content repository, it could violate security compliance principles and pose a risk of data breach for the organization.

For example, one common feature in enterprise software is attachment functionality. In some circumstances, multiple steps of transactions can refer to a shared document stored in the cloud-based content repository. The shared document can be configured as an attachment file linked to different objects, with each object representing a corresponding entity involved in the transactions. If the service provider of the enterprise software can access and create a local copy of the attachment file during testing and/or performing maintenance of the enterprise software, then it could violate the data security protocols because there is a risk that sensitive information contained in the attachment file may be exposed to unauthorized users who have access to the local copy of the attachment file.

Specifically, an enterprise software may allow a user to attach an electronic document stored in the content repository to multiple objects (representing different entities involved in multiple steps of transactions). For example, using the enterprise software, the user can attach the electronic document associated with one object (or “source object”) to other objects (or “target object”). To test such attachment functionality in a software testing environment (i.e., to perform a software testing to verify if an electronic document stored in a remote content repository can be attached to an object), either by means of manual testing or automatic testing (e.g., a bot running a scripted test software), one conventional approach is to first download the electronic document associated with the source object from the content repository to a local machine to create a local copy, and then attach the local copy to selected target objects. However, by creating the local copy of the electronic document, sensitive information stored in the electronic document may be exposed to any users who have access to the local machine and the local copy stored therein.

The technologies described herein provide a system and method that support secure testing of attachment functionality of objects in an enterprise software. As described more fully below, the described technologies allow testing of attachment functionalities of objects without downloading or creating a local copy of the attachment document, thereby leaving zero footprint of the content of the attachment document in the software testing environment.

### Example 2—Example Objects

Many transactions conducted by an organization can be modelled in a software application as data objects, or simply “object,” or sometimes “business objects.” In any of the examples described herein, an object can comprise a definition of a data structure and definitions of one or more operations that can be performed using portions of the data structure. Examples of such objects include classes (such as object-oriented classes). In some examples, the data structure can be a hierarchical data structure. Additionally, or alternatively, multiple objects may be organized in a hierarchy (such as an inheritance hierarchy that is defined by inheritance relationships between the objects). In some cases, the objects can take any number of forms including business intelligence or performance management components such as those implemented in software technologies of SAP BusinessObjects, provided by SAP SE, of Walldorf, Germany or others. However, the use of objects in computer applications is not limited to “business” scenarios. For example, objects can be used to define a particular application and/or problem domain space. Aspects and artifacts of a given problem domain can be defined using data structures. Various portions of these aspects and/or artifacts can be associated directly or indirectly with definitions of logical operations.

Additionally, or alternatively, objects can comprise units of programming language source code (such as modules, object-oriented class definitions, functions, views, libraries, packages, etc.). In at least some embodiments, objects can comprise units of programming language source code that are managed by a version control system. However, it is also possible for units of programming language source code that are managed by a version control system to include multiple objects. For example, a version control system may manage source code files which may in turn contain multiple objects (such as a scenario where a single source code file contains multiple class definitions). For example, a single file may contain multiple class definitions, or a class may be defined by multiple files. In such scenarios, a version control system may manage the source code at the file level, while the class definitions are treated as the objects.

In some circumstances, each object can have an object type, which represents a class or type of entity modeled by the object. For example, the object type can be “employee,” “sales order,” etc. The object type can comprise both the functionality (e.g., in the form of methods) and data (e.g., in the form of attributes) of the modeled entity. The implementation details of the objects can be encapsulated (i.e., hidden from end users), while application programming interfaces (APIs) can be provided for end users to access data and functionality of the object type. In some cases, a user can define a new object type and/or edit an existing object type.

In some circumstances, each object can also have an object key. The object key may comprise one or multiple key fields, which can be used to identify an individual single instance of a specific object type. In some examples, the combination of object type and object key can uniquely identify a specific entity (e.g., a specific employee that is an instance of the “employee” object type, a specific sales order that is an instance of the “sales order” object type, etc.).

In practice, the term “object” is often used as shorthand for “object instance.” For example, any stored representation of an object type typically takes the form of an object instance of the object type that has actual attribute values (field values) that represent characteristics of the represented entity. When an object is “received,” typically an object instance of the object type or a reference to the object instance is received.

### Example 3—Example Testing Process of Objects with Attachments

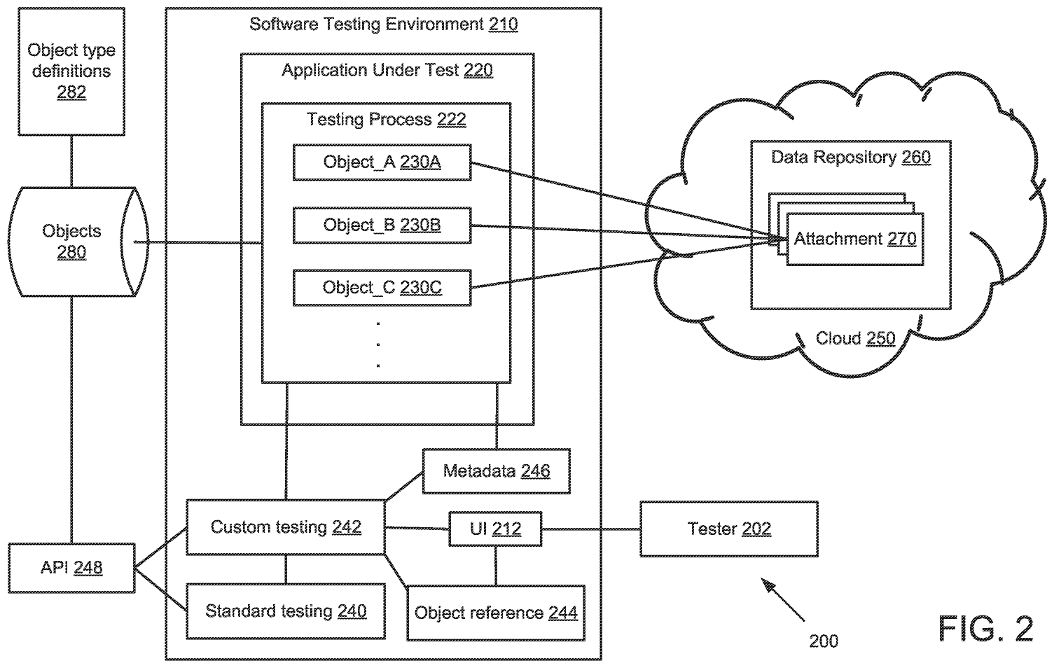

As noted above, an organization can use an enterprise software to manage multiple steps of transactions, where each transaction step can involve an entity modeled by a corresponding object. One use case is shown in FIG. 2 as an example. In this use case, an organization plans to purchase different parts of a machine (e.g., a computer) from different vendors. The process can start from the organization approaching different vendors to request price quotes for different parts of the machine. Based on received sales quotation 210, the organization can enter into sales contract 220 with different vendors. Then based on the sales contracts 220, the organization can generate respective sales orders 230. Thereafter, the organization can receive billing documents 240 corresponding to the sales orders 230. All these entities, including the sales quotations 210, sales contracts 220, sales orders 230, and billing documents 240, can be modeled as corresponding objects and processed by the enterprise software.

In this example, each sales contract 220 can be written in a way that directly refers to or includes information contained in the corresponding sales quotation 210 (e.g., the type and quantity of a part to be purchased from a particular vendor, the delivery place/date, etc.). Alternatively, the sales contract 220 can be devoid of such specific information. Instead, the corresponding sales quotation 210 can be simply linked to the sales contract 220 as an attachment document. This can be desirable because the sales contract 220 can be used as an independent document itself (or a generic sales contract). In other words, the organization can use the same generic sales contract 220 to purchase different parts from different vendors by attaching corresponding sales quotations 210 (and there is no need to change the sales contract 220 to specifically refer to or explicitly include information contained in different sales quotations 210).

Similarly, in one approach, a sales order 230 can directly refer to or explicitly include information about a particular sales contract 220, and a billing document 240 can directly refer to or explicitly include information about a specific sales order 230. This approach will create a dependency or tight coupling between different transaction steps (e.g., a specific billing document 240 refers to a specific sales order 230, which refers to a specific sales contract 220). Alternatively, the sales order 230 and the billing document 240 can be devoid of vendor-specific information and used independently. For example, the sales order 230 can simply refer to the generic sales contract 220 discussed above (thus, a generic sales order), and the billing document 240 can simply refer to the generic sales order (thus, a generic billing document). According to this approach, different sales orders 230 can be created by attaching corresponding sales quotations 210 to the generic sales order, and different billing documents 240 can be generated by attaching corresponding sales quotations 210 to the generic billing document. This approach can be desirable because it removes the dependency or tight coupling between different transaction steps.

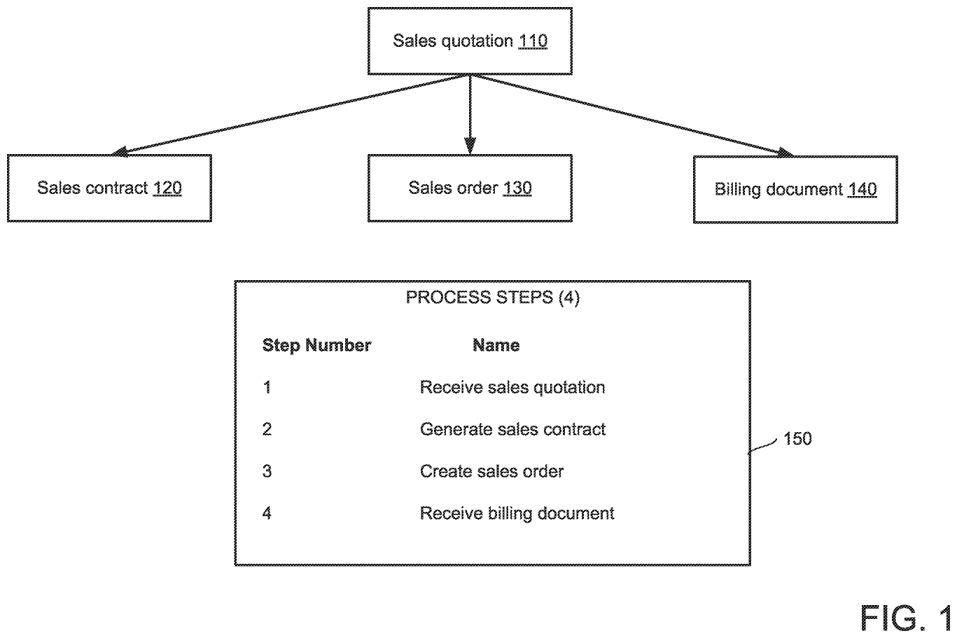

As this use case illustrates, the attachment functionality can be important for the enterprise software to manage a large number of objects involved in complex transactions. As an example, FIG. 1 also depicts a testing process 150 that can be implemented in a software testing environment. As shown, the testing process 150 includes four testing steps corresponding to the four objects described above: (1) receive sales quotation 210; (2) generate sales contract 220; (3) create sales order 230; and (4) receive billing document 240. To test the attachment functionality described above, a tester (e.g., a person or a bot) needs to test if the sales quotation associated with step (1) can be successfully attached to objects in steps (2), (3) and (4), respectively. Thus, in this example, the sales quotation 110 acts as the source object and the sales contract 120, sales order 130, and billing document 140 act as the target objects.

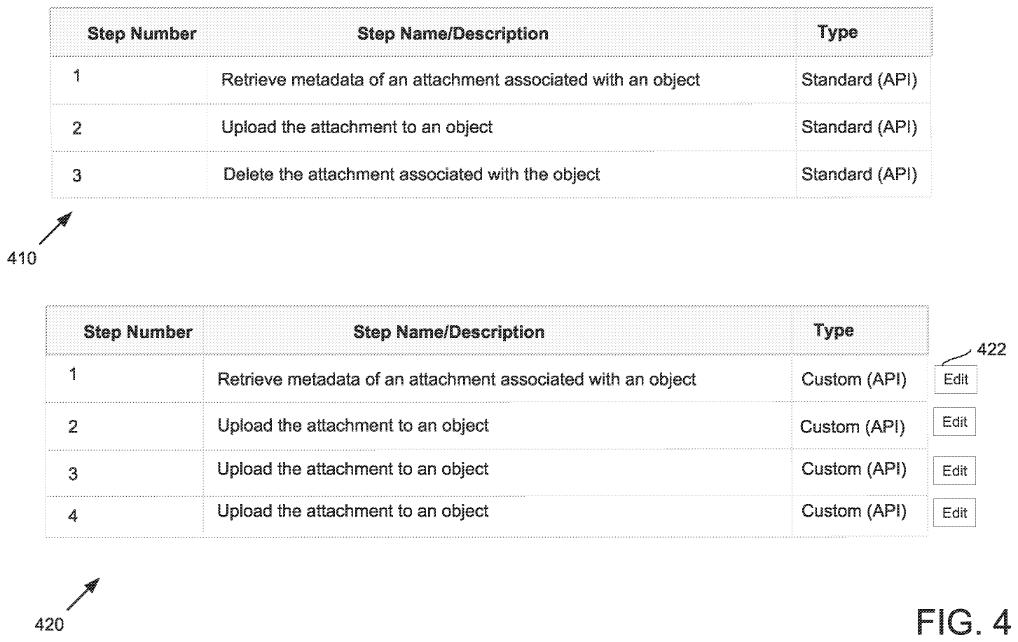

The testing process 150 can be edited to test additional attachment functionalities. In one example, let us assume that the sales quotation 110 acts as a source object with a quotation attachment, and this quotation document can be referenced by and attached to the sales contract 120, which acts as a target object. In case the quotation attachment is no longer valid or has changed information (e.g., changes in quotation price, etc.), then this quotation attachment needs to be deleted from the target object (e.g., sales contract 120). Thus, the testing process 150 can be edited to test whether the quotation attachment associated with the target object can be deleted from the content repository. One example testing step to test such deleting functionality is depicted in a standard testing program 410 of FIG. 4.

As another example, still assuming that the sales quotation 110 originally acts as a source object with a quotation attachment, and this quotation document is referenced by and attached to the sales contract 120, which acts as a target object. Now, the sales contract 120 can acts as a new source object, and the same attachment associated with the sales contract 120 can be referenced by and attached to another object, e.g., the sales order 130, which acts as a new target object. Thus, the testing process 150 can be edited to test this attachment scenario. More generally, the testing process 150 can be edited to allow a tester to test various source-target object configurations (e.g., to designate any one of the listed objects as a source object with an attachment and select one or more target objects).

The challenge, as described above and addressed herein, is to securely test the attachment functionality of the testing process 150 as illustrated above without downloading or leaving any footprint of the content of the attachment document (e.g., the sales quotation 210) in the software testing environment.

### Example 4—Example Overall System Supporting Secure Software Testing of Attachment Functionality of Objects

FIG. 2 shows an overall block diagram of an example system 200 supporting secure software testing on objects sharing an attachment document.

As shown, a tester 202, such a testing person or a bot running a scripted testing software, can log on and access a software testing environment 210, e.g., through a user interface (UI) 212 of the software testing environment 210. The software testing environment 210 includes an application under test 220, such as an enterprise software supporting the testing of attachment functionality of objects. The application under test 220 can define a testing process 222 similar to the testing process 150 described above. For example, the testing process 222 can include a plurality of steps involving different objects, such as Object_A 230A, Object_B 230B, Object_C 230C, etc. (collectively, 230).

These objects 230 can be retrieved from an object database 280, which stores a plurality of objects modeling different entities. The objects stored in the database 280 can be instances of different object types, which can be defined in an object type definition database 282 associated with the application under test 220. In some examples, the service provider of the application under test 220 can provide the object type definitions stored in the database 282. In some examples, users of the application under test 220 can create new and/or edit existing object type definitions in the database 282. Additionally, users of the application under test 220 can instantiate, edit, and/or delete objects stored in the object database 280.

In the depicted example, the object database 280 and the object definition database 282 are external to the software testing environment 210. In other examples, the object database 280 and/or the object definition database 282 can be internal or integrated with the software testing environment 210.

As shown, at least some objects 230 included in the testing process 222 can share an attachment document 270 stored in a data repository 260 that is specific to an organization. The organization-specific data repository 260 can be remotely located in a cloud 250, which can provide cloud services to serve multiple organizations (or tenants), where each tenant has its own data repository.

The software testing environment 210 can include a standard testing program 240 (also referred to as a testing template application). As described further below, the standard testing program 240 comprises at least one retrieving step and one uploading step. The retrieve step can invoke a data retrieval operation from a source object, and the uploading step can invoke a data uploading operation to a target object. But both the source and the target objects are unspecified in the standard testing program 240.

Through the user interface 212, the tester 202 can create custom testing programs 242 using the standard testing program 240 as a template. As an example, the tester 202 can create a custom testing program 242 that is specific to the testing process 222 that involves the objects 230. As described below, the tester 202 can modify the custom testing programs 242 via the user interface 212. For example, the tester 202 can identify a source object (from the objects 230) in the retrieving step and specify target objects (from the objects 230) in one or more uploading steps. Identification of the source object and the target objects can be achieved, e.g., by providing respective object references 244 through the user interface 212.

The retrieve steps and uploading steps in the standard testing program 240 and custom testing programs 242 can make corresponding function or method calls through an application programming interface (API) 248. These function or method calls can be implemented in any programming languages (e.g., JAVA, C #, etc.). Through the API 248, the method calls can access data elements of selected objects stored in the object database 280. For example, some method calls can retrieve information (or read) from a specified object, whereas some method calls can post information (or write) to a specified object, as described further below.

Through the user interface 212, the tester 202 can run the custom testing program 242 which in turn executes the testing process 222. As described further below, the retrieving step of the custom testing program 242 can retrieve metadata about the attachment document 270 associated with the source object and temporarily store the metadata in a memory buffer 246. The retrieved metadata can provide a unique reference to the attachment document 270 stored in the data repository 260. Then, the uploading steps of the custom testing program 242 can pass or post the metadata to the respective target objects, thereby linking the attachment document 270 to the target objects. As such, the testing process 222 can test the target objects with the linked attachment document 270.

Because only the metadata of the attachment document 270 is passed to the target objects and no local copy or content of the attachment document 270 is stored anywhere in the software testing environment 210, the tester 202 cannot access information stored in the attachment document 270. In other words, the attachment document 270 is not accessible to the tester 202 via user interfaces (e.g., 212) of the software testing environment 210.

In practice, the systems shown herein, such as system 200, can vary in complexity, with additional functionality, more complex components, and the like. For example, there can be additional functionality within the software testing environment 210. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 200 and any of the other systems described herein can be implemented in conjunction with any of the hardware components described herein, such as the computing systems described below (e.g., processing units, memory, and the like). In any of the examples herein, the metadata, the objects, the standard/custom testing programs, and the like can be stored in one or more computer-readable storage media or computer-readable storage devices. The technologies described herein can be generic to the specifics of operating systems or hardware and can be applied in any variety of environments to take advantage of the described features.

### Example 5—Example Overall Method of Performing Secure Software Testing of Attachment Functionality of Objects

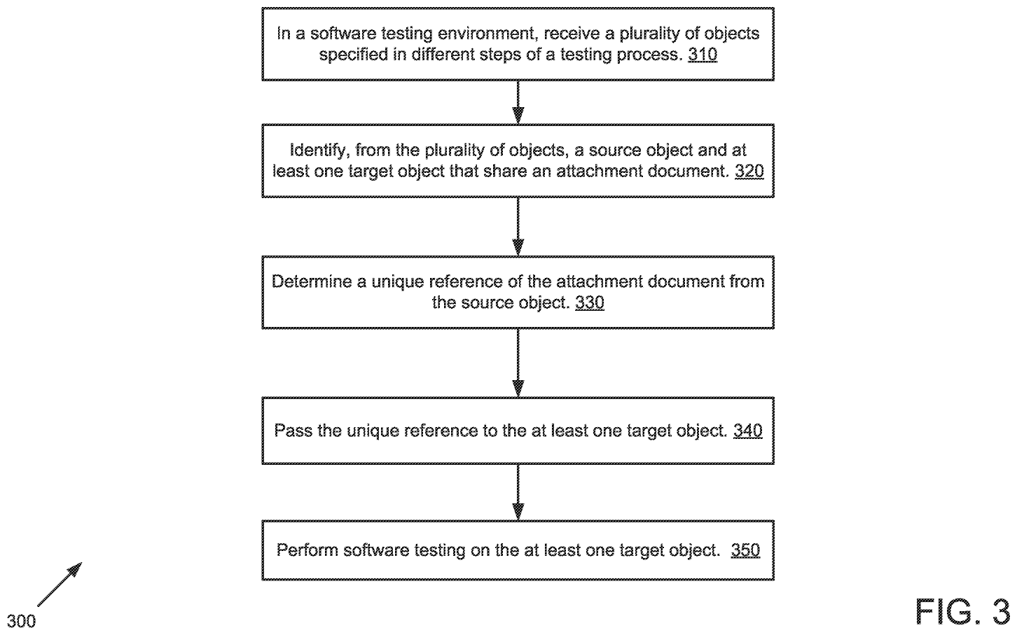

FIG. 3 is a flowchart illustrating an overall method 300 of performing secure software testing on objects sharing an attachment document, and can be performed, for example, by the system 200 of FIG. 2.

At 310, in a software testing environment (e.g., 210), the method 300 can receive a plurality of objects (e.g., 230) specified in different steps of a testing process (e.g., 222). As noted above, the objects represent or model corresponding entities involved in transactions.

At 320, from the plurality of objects, a source object and at least one target object that share an attachment document (e.g., 270) stored in a cloud-based data repository (e.g., 260) can be identified. For example, the tester 202 can provide respective object references 244 through the user interface 212 to identify the source object and the target objects.

At 330, a unique reference of the attachment document can be determined from the source object. In some examples, determining the unique reference can comprise retrieving metadata of the attachment document associated with the source object.

At 340, the unique reference of the attachment document can be passed (or uploaded) to the at least one target object, thereby linking the attachment document to the at least one target object. In some examples, passing/uploading the unique reference can comprise passing/uploading the metadata of the attachment document to the at least one target object.

In some examples, passing/uploading the metadata can further comprise linking a step number to the at least one target object, wherein the step number specifies which step of the testing process involves the source object.

Then, at 350, the method 300 can perform software testing on the at least one target object. The software testing on the at least one target object can verify that the attachment document stored in the cloud-based data repository is attached to the at least one target object via the unique reference, while the attachment document is not accessible via user interfaces of the software testing environment. The unique reference thus prevents exposure of the attachment document (e.g., to users who are executing the testing environment).

The method 300 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “receive” can also be described as “send” from a different perspective.

### Example 6—Example Standard and Custom Testing Programs

FIG. 4 shows an example standard testing program 410 and a customer testing program 420.

In the depicted example, the standard testing program 410 includes three testing steps: (1) retrieve metadata of an attachment associated with an object; (2) upload the attachment to an object; and (3) delete the attachment associated with the object. The object in step 1 represents a source object, and the act of retrieving can be implemented by invoking a method call (e.g., via the API 248) to retrieve metadata of a document attached to the source object. The retrieved metadata can serve as a unique reference of the document attached to the source object. The source object, however, is merely a parameter and left unspecified (i.e., not defined) in the standard testing program 410. The object in step 2 represents a target object, and the act of uploading can be implemented by invoking a method call (e.g., via the API 248) to pass a unique reference of a document to the target object. The target object, however, is merely a parameter and left unspecified (i.e., not defined) in the standard testing program 410. The unique reference of the document to be passed to the target object is also parameterized (i.e., not specified) in the standard testing program 410. The act of deleting in step 3 can invoke a method call (e.g., via the API 248) to cause an attachment document associated with an object to be deleted from the data repository. The object in step 3, however, is also unspecified in the standard testing program 410.

The custom testing program 420 can be created using the standard testing program 410 as a template. In the depicted example, the custom testing program 420 includes four steps, including one retrieval step (step 1) and three uploading steps (steps 2-4). The first retrieval step can be duplicated from the first step of standard testing program 410. However, a tester can specify or define the source object by editing the first step (e.g., by clicking an edit button 422 next to the step). The three uploading steps can be duplicated from the second step of the standard testing program 410. Similarly, the tester can specify or define respective target object by editing each of steps 2-4 (e.g., by clicking an edit button 422 next to the step). In the depicted example, the deleting step (i.e., step 3) of the standard testing program 410 is removed (e.g., by the tester) from the custom testing program 420, thus no attachment is deleted from the data repository after running the custom testing program 420. In other examples, the tester can keep the deleting step in the custom testing program 420 and specify which attachment will be deleted from the data repository.

### Example 7—Example Object Identification and Metadata of Attachment

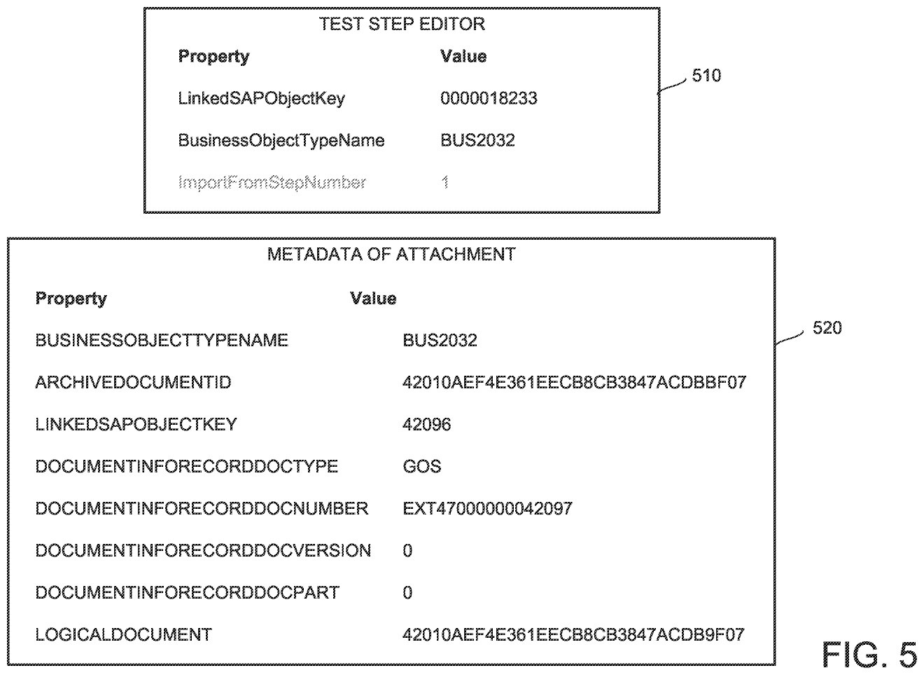

FIG. 5 shows an example test step editor 510 which can be used by a tester to edit a test step in a custom testing program (e.g., by clicking the edit button 422 next to the step). Specifically, the test step editor 510 can be used to specify or define an object (e.g., a source object or a target object) in a test step.

As described above in certain circumstances, each object can have an object type and an object key. The object type can represent a type of entity, and the object key can be used to identify an individual instance of a specific object type. In some cases, the combination of object type and object key can be used to uniquely identify an object. In the depicted example, the test step editor 510 is configured to allow a tester to enter specific values to the object type (with property name “BusinessObjectTypeName”) and object key (with property name “LinkedSAPObjectKey”). Thus, the tester can specify the source object in a test step by providing an object key and object type name corresponding to the source object. Similarly, the tester can specify the target object in a test step by providing an object key and object type name corresponding to the target object.

In some examples, for uploading steps (e.g., steps 2-4 in the custom testing program 420), the tester can also specify a step number via the test step editor 510. The step number (labelled as “ImportFromStepNumber”) can specify which step of the testing process involves the source object. For example, for the custom testing program 420, the step number for each of the three uploading steps can be set to 1 because the source object is specified in the first retrieval step.

After defining the source object and the target objects in various testing steps, the custom testing program (e.g., 420) can be executed on the software testing environment. Running the retrieval step (e.g., step 1 of 420) can invoke a method call to retrieve metadata of an attachment document associated with the specified source object. An example list of metadata is depicted in 520 of FIG. 5. In the depicted example, the metadata of the attachment includes the following attributes and corresponding values for the attributes: BUSINESSOBJECTTYPENAME, ARCHIVEDOCUMENTID, LINKEDSAPOBJECTKEY, DOCUMENTINFORECORDDOCTYPE, DOCUMENTINFORECORDDOCNUMBER, DOCUMENTINFORECORDDOCVERSION, DOCUMENTINFORECORDDOCPART, LOGICALDOCUMENT. These metadata, collectively, can serve a unique reference to the attachment document stored in the cloud-based data repository.

Then, running the uploading steps (e.g., steps 2-4 of 420) can invoke a method call to pass/upload the retrieved metadata to the specified target objects, thereby linking the attachment document to the target objects for object testing purposes. In some examples, the retrieved metadata (including the listed attributes and their corresponding values) can be temporarily stored in a memory buffer (e.g., 246). The retrieval step can maintain a reference to the retrieved metadata stored in the memory buffer. Thus, instead of directly passing the retrieved metadata to the target objects (e.g., by entering the metadata of the attachment document in the test step editor 510), the reference to the retrieved metadata can be passed to the target objects (e.g., by specifying the step number “ImportFromStepNumber” which corresponds to the retrieval step). The uploading steps can obtain metadata of the attachment document indirectly through the reference of the retrieval step, which is identified by the step number entered through the test step editor 510.

### Example 8—Example Advantages

A number of advantages can be achieved via the technologies described herein. For example, the technologies described herein provides a software testing environment that can securely test attachment functionality of objects in an enterprise software. While objects can be directly accessed for testing in the software testing environment, electronic documents attached to the objects can be remotely stored in a cloud-based data repository. The software testing environment can test attachment functionalities of the objects without the need of downloading or creating a local copy of the attachment document, thereby leaving zero footprint of the content of the attachment document in the software testing environment.

As described above, the software testing environment can greatly simplify the testing process by providing a standard testing program, based on which a tester can easily create customer testing programs for different testing processes. The tester can specify source and target objects in the custom testing programs, which can retrieve metadata (or a unique reference) of the attachment from the source object, and pass/upload the metadata (or the unique reference) of the attachment to the target objects. Conveniently, the custom testing program can include multiple testing steps involving different target objects which share one common attachment.

### Example 9—Example Computing Systems

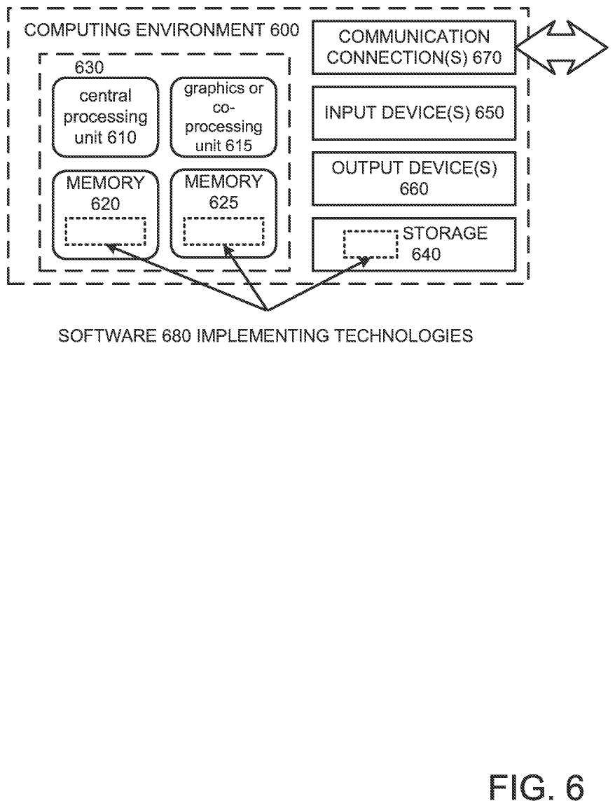

FIG. 6 depicts an example of a suitable computing system 600 in which the described innovations can be implemented. The computing system 600 is not intended to suggest any limitation as to scope of use or functionality of the present disclosure, as the innovations can be implemented in diverse computing systems.

With reference to FIG. 6, the computing system 600 includes one or more processing units 610, 615 and memory 620, 625. In FIG. 6, this basic configuration 630 is included within a dashed line. The processing units 610, 615 can execute computer-executable instructions, such as for implementing the features described in the examples herein (e.g., the method 300). A processing unit can be a general-purpose central processing unit (CPU), processor in an application-specific integrated circuit (ASIC), or any other type of processor. In a multi-processing system, multiple processing units can execute computer-executable instructions to increase processing power. For example, FIG. 6 shows a central processing unit 610 as well as a graphics processing unit or co-processing unit 615. The tangible memory 620, 625 can be volatile memory (e.g., registers, cache, RAM), non-volatile memory (e.g., ROM, EEPROM, flash memory, etc.), or some combination of the two, accessible by the processing unit(s) 610, 615. The memory 620, 625 can store software 680 implementing one or more innovations described herein, in the form of computer-executable instructions suitable for execution by the processing unit(s) 610, 615.

A computing system 600 can have additional features. For example, the computing system 600 can include storage 640, one or more input devices 650, one or more output devices 660, and one or more communication connections 670, including input devices, output devices, and communication connections for interacting with a user. An interconnection mechanism (not shown) such as a bus, controller, or network can interconnect the components of the computing system 600. Typically, operating system software (not shown) can provide an operating environment for other software executing in the computing system 600, and coordinate activities of the components of the computing system 600.

The tangible storage 640 can be removable or non-removable, and includes magnetic disks, magnetic tapes or cassettes, CD-ROMs, DVDs, or any other medium which can be used to store information in a non-transitory way and which can be accessed within the computing system 600. The storage 640 can store instructions for the software 280 implementing one or more innovations described herein.

The input device(s) 650 can be an input device such as a keyboard, mouse, pen, or trackball, a voice input device, a scanning device, touch device (e.g., touchpad, display, or the like) or another device that provides input to the computing system 600. The output device(s) 660 can be a display, printer, speaker, CD-writer, or another device that provides output from the computing system 600.

The communication connection(s) 670 can enable communication over a communication medium to another computing entity. The communication medium can convey information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components can include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer, and should not be confused with acts performed by a human being. The actual computer operations corresponding to these terms vary depending on implementation.

### Example 10—Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example 11—Example Cloud Computing Environment

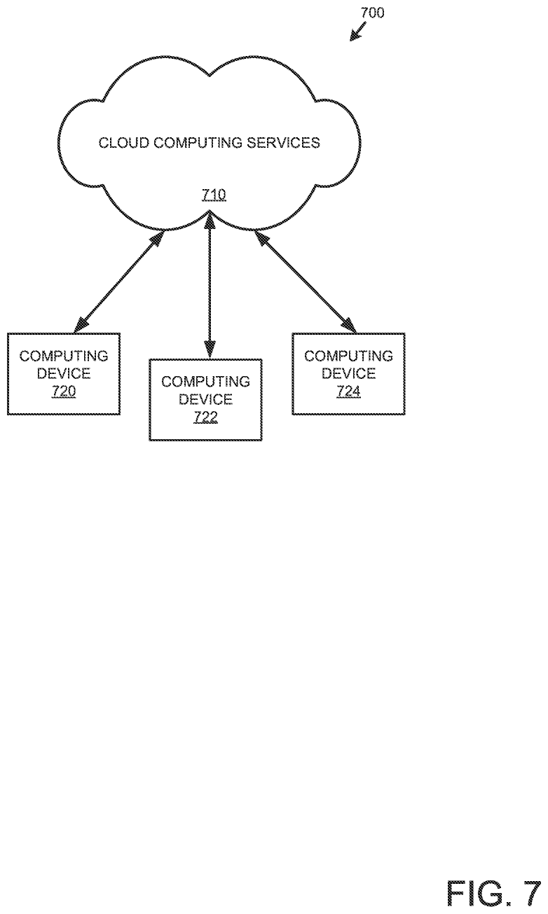

FIG. 7 depicts an example cloud computing environment 700 in which the described technologies can be implemented, including, e.g., the system 200 and other systems herein. The cloud computing environment 700 can include cloud computing services 710. The cloud computing services 710 can comprise various types of cloud computing resources, such as computer servers, data storage repositories, networking resources, etc. The cloud computing services 710 can be centrally located (e.g., provided by a data center of a business or organization) or distributed (e.g., provided by various computing resources located at different locations, such as different data centers and/or located in different cities or countries).

The cloud computing services 710 can be utilized by various types of computing devices (e.g., client computing devices), such as computing devices 720, 722, and 723. For example, the computing devices (e.g., 720, 722, and 724) can be computers (e.g., desktop or laptop computers), mobile devices (e.g., tablet computers or smart phones), or other types of computing devices. For example, the computing devices (e.g., 720, 722, and 724) can utilize the cloud computing services 710 to perform computing operations (e.g., data processing, data storage, and the like).

In practice, cloud-based, on-premises-based, or hybrid scenarios can be supported.

### Example 12—Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

As described in this application and in the claims, the singular forms “a,” “an,” and “the” include the plural forms unless the context clearly dictates otherwise. Additionally, the term “includes” means “comprises.” Further, “and/or” means “and” or “or,” as well as “and” and “or.”

### Example 13—Example Embodiments

Any of the following example embodiments can be implemented.

Example 1. A computer-implemented method comprising: in a software testing environment, receiving a plurality of objects specified in different steps of a testing process; identifying, from the plurality of objects, a source object and at least one target object that share an attachment document, wherein the attachment document is stored in a cloud-based data repository; determining a unique reference of the attachment document from the source object; passing the unique reference to the at least one target object; and performing software testing on the at least one target object, wherein the software testing on the at least one target object verifies that the attachment document stored in the cloud-based data repository is attached to the at least one target object via the unique reference.

Example 2. The method of example 1, wherein the attachment document is not accessible via user interfaces of the software testing environment.

Example 3. The method of any one of examples 1-2, wherein the determining the unique reference comprises retrieving metadata of the attachment document associated with the source object.

Example 4. The method of example 3, wherein the passing the unique reference comprises passing the metadata of the attachment document to the at least one target object.

Example 5. The method of example 4, wherein passing the metadata comprises linking a step number to the at least one target object, wherein the step number specifies which step of the testing process involves the source object.

Example 6. The method of any one of examples 1-5, wherein the identifying the source object comprises providing an object key and an object type name of the source object through a user interface of the software testing environment.

Example 7. The method of example 6, wherein the identifying the at least one target object comprises providing an object key and an object type name of the at least one target object through the user interface of the software testing environment.

Example 8. The method of any one of examples 1-7, wherein the software testing environment comprises a testing template application, wherein the testing template application comprises at least one retrieving step and one uploading step, wherein the retrieving step invokes a data retrieval operation from a first object, wherein the uploading step invokes a data uploading operation to a second object, wherein the first and second objects are undefined.

Example 9. The method of example 8, further comprising generating a custom testing application from the testing template application, wherein the generating the customer testing application comprises defining the source object in the retrieving step and defining the at least one target object in the uploading step.

Example 10. The method of any one of examples 1-9, further comprising deleting the attachment document from the cloud-based data repository via the software testing environment.

Example 11. A computing system, comprising: memory; one or more hardware processors coupled to the memory; and one or more computer readable storage media storing instructions that, when loaded into the memory, cause the one or more hardware processors to perform operations comprising: in a software testing environment, receiving a plurality of objects specified in different steps of a testing process; identifying, from the plurality of objects, a source object and at least one target object that share an attachment document, wherein the attachment document is stored in a cloud-based data repository; determining a unique reference of the attachment document from the source object; passing the unique reference to the at least one target object; and performing software testing on the at least one target object, wherein the software testing on the at least one target object verifies that the attachment document stored in the cloud-based data repository is attached to the at least one target object via the unique reference.

Example 12. The system of example 11, wherein the attachment document is not accessible via user interfaces of the software testing environment.

Example 13. The system of any one of examples 11-12, wherein the operation of determining the unique reference comprises retrieving metadata of the attachment document associated with the source object.

Example 14. The system of example 13, wherein the operation of passing the unique reference comprises passing the metadata of the attachment document to the at least one target object.

Example 15. The system of any one of examples 11-14, wherein the operation of identifying the source object comprises providing an object key and an object type name of the source object through a user interface of the software testing environment.

Example 16. The system of example 15, wherein the operation of identifying the at least one target object comprises providing an object key and an object type name of the at least one target object through the user interface of the software testing environment.

Example 17. The system of any one of examples 11-16, wherein the software testing environment comprises a testing template application, wherein the testing template application comprises at least one retrieving step and one uploading step, wherein the retrieving step invokes a data retrieval operation from a first object, wherein the uploading step invokes a data uploading operation to a second object, wherein the first and second objects are undefined.

Example 18. The system of example 17, wherein the operations further comprise generating a custom testing application from the testing template application, wherein the generating the customer testing application comprises defining the source object in the retrieving step and defining the at least one target object in the uploading step.

Example 19. The system of any one of examples 11-18, wherein the operations further comprise deleting the attachment document from the cloud-based data repository via the software testing environment.

Example 20. One or more non-transitory computer-readable media having encoded thereon computer-executable instructions causing one or more processors to perform a method comprising: in a software testing environment, receiving a plurality of objects specified in different steps of a testing process; identifying, from the plurality of objects, a source object and at least one target object that share an attachment document, wherein the attachment document is stored in a cloud-based data repository; determining a unique reference of the attachment document from the source object; passing the unique reference to the at least one target object; and performing software testing on the at least one target object, wherein the software testing on the at least one target object verifies that the attachment document stored in the cloud-based data repository is attached to the at least one target object via the unique reference, wherein the attachment document is not accessible via user interfaces of the software testing environment, wherein the determining the unique reference comprises retrieving metadata of the attachment document associated with the source object, wherein the passing the unique reference comprises passing the metadata of the attachment document to the at least one target object.

### Example 14—Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method comprising:
in a software testing environment, receiving a plurality of objects specified in different steps of a testing process;
identifying, from the plurality of objects, a source object and at least one target object that share an attachment document, wherein the attachment document is stored in a cloud-based data repository;
determining a unique reference of the attachment document from the source object;
passing the unique reference to the at least one target object; and
performing software testing on the at least one target object, wherein the software testing on the at least one target object verifies that the attachment document stored in the cloud-based data repository is attached to the at least one target object via the unique reference.

2. The method of claim 1, wherein the attachment document is not accessible via user interfaces of the software testing environment.

3. The method of claim 1, wherein the determining the unique reference comprises retrieving metadata of the attachment document associated with the source object.

4. The method of claim 3, wherein the passing the unique reference comprises passing the metadata of the attachment document to the at least one target object.

5. The method of claim 4, wherein passing the metadata comprises linking a step number to the at least one target object, wherein the step number specifies which step of the testing process involves the source object.

6. The method of claim 1, wherein the identifying the source object comprises providing an object key and an object type name of the source object through a user interface of the software testing environment.

7. The method of claim 6, wherein the identifying the at least one target object comprises providing an object key and an object type name of the at least one target object through the user interface of the software testing environment.

8. The method of claim 1, wherein the software testing environment comprises a testing template application, wherein the testing template application comprises at least one retrieving step and one uploading step, wherein the retrieving step invokes a data retrieval operation from a first object, wherein the uploading step invokes a data uploading operation to a second object, wherein the first and second objects are undefined.

9. The method of claim 8, further comprising generating a custom testing application from the testing template application, wherein the generating the customer testing application comprises defining the source object in the retrieving step and defining the at least one target object in the uploading step.

10. The method of claim 1, further comprising deleting the attachment document from the cloud-based data repository via the software testing environment.

11. A computing system, comprising:
memory;
one or more hardware processors coupled to the memory; and
one or more computer readable storage media storing instructions that, when loaded into the memory, cause the one or more hardware processors to perform operations comprising:
in a software testing environment, receiving a plurality of objects specified in different steps of a testing process;
identifying, from the plurality of objects, a source object and at least one target object that share an attachment document, wherein the attachment document is stored in a cloud-based data repository;
determining a unique reference of the attachment document from the source object;
passing the unique reference to the at least one target object; and
performing software testing on the at least one target object, wherein the software testing on the at least one target object verifies that the attachment document stored in the cloud-based data repository is attached to the at least one target object via the unique reference.

12. The system of claim 11, wherein the attachment document is not accessible via user interfaces of the software testing environment.

13. The system of claim 11, wherein the operation of determining the unique reference comprises retrieving metadata of the attachment document associated with the source object.

14. The system of claim 13, wherein the operation of passing the unique reference comprises passing the metadata of the attachment document to the at least one target object.

15. The system of claim 11, wherein the operation of identifying the source object comprises providing an object key and an object type name of the source object through a user interface of the software testing environment.

16. The system of claim 15, wherein the operation of identifying the at least one target object comprises providing an object key and an object type name of the at least one target object through the user interface of the software testing environment.

17. The system of claim 11, wherein the software testing environment comprises a testing template application, wherein the testing template application comprises at least one retrieving step and one uploading step, wherein the retrieving step invokes a data retrieval operation from a first object, wherein the uploading step invokes a data uploading operation to a second object, wherein the first and second objects are undefined.

18. The system of claim 17, wherein the operations further comprise generating a custom testing application from the testing template application, wherein the generating the customer testing application comprises defining the source object in the retrieving step and defining the at least one target object in the uploading step.

19. The system of claim 11, wherein the operations further comprise deleting the attachment document from the cloud-based data repository via the software testing environment.

20. One or more non-transitory computer-readable media having encoded thereon computer-executable instructions causing one or more processors to perform a method comprising:
in a software testing environment, receiving a plurality of objects specified in different steps of a testing process;
identifying, from the plurality of objects, a source object and at least one target object that share an attachment document, wherein the attachment document is stored in a cloud-based data repository;
determining a unique reference of the attachment document from the source object;
passing the unique reference to the at least one target object; and
performing software testing on the at least one target object, wherein the software testing on the at least one target object verifies that the attachment document stored in the cloud-based data repository is attached to the at least one target object via the unique reference,
wherein the attachment document is not accessible via user interfaces of the software testing environment,
wherein the determining the unique reference comprises retrieving metadata of the attachment document associated with the source object,
wherein the passing the unique reference comprises passing the metadata of the attachment document to the at least one target object.
